(19) United States
(12) Patent Application Publication
(10) Pub. No.: US 2025/0310041 A1
(43) Pub. Date: Oct. 2, 2025

(54) ELECTRONIC DEVICE AND METHOD USED IN WIRELESS COMMUNICATION SYSTEM

(71) Applicant: Sony Group Corporation, Tokyo (JP)

(72) Inventors: Jinhui CHEN, Beijing (CN); Haojin LI, Beijing (CN)

(73) Assignee: Sony Group Corporation, Tokyo (JP)

(21) Appl. No.: 18/878,818

(22) PCT Filed: Jun. 28, 2023
(86) PCT No.: PCT/CN2023/103081

§ 371 Date: Dec. 24, 2024

(30) Foreign Application Priority Data
Jul. 1, 2022 (CN) 202210775178.8

(51) Int. Cl. H04L 5/00; H04L 27/26; H04W 4/029

(52) U.S. Cl. CPC H04L 5/0005; H04L 27/261; H04W 4/029

(57) ABSTRACT

The present disclosure relates to an electronic device and method used in a wireless communication system. The present disclosure proposes a method for a first user equipment in a wireless communication system. The method comprises: receiving, through a first antenna panel installed on the first user equipment, a reference signal transmitted by a third antenna panel of a second user equipment installed thereon, wherein a time resource and/or frequency resource occupied by the reference signal are associated with the position of the third antenna panel on the second user equipment; and determining, based on an association relationship between the position of the third antenna panel on the second user equipment and one or more time resources and/or frequency resources and the time resource and/or frequency resource occupied by said reference signal, the position of the third antenna panel on the second user equipment.

### CLAIM OF PRIORITY

This application claims priority to Chinese patent application with application No. 202210775178.8, titled “ELECTRONIC DEVICE AND METHOD FOR WIRELESS COMMUNICATION SYSTEM”, filed on Jul. 1, 2022, the entire contents of which is incorporated herein by reference.

### TECHNICAL FIELD

The present disclosure relates generally to electronic devices and methods used in wireless communication systems, and specifically, to technologies for wireless sidelink communications.

### BACKGROUND

Wireless communication systems may use a variety of protocols and standards for data transmission between devices. These protocols and standards have experienced long-term development, including but not limited to the 3rd Generation Partnership Project (3GPP), 3GPP Long Term Evolution (LTE) (for example, 4G communications), 3GPP New Radio (NR) (for example, 5G communications), and the IEEE 802.11 standard for Wireless Local Area Networks (WLAN) (also commonly referred to as Wi-Fi), among others.

As an example, in an LTE or NR system, communication interfaces between user equipments (also referred to herein as terminal devices) include a PC5 interface. The PC5 interface may be used for scenarios such as vehicle-to-everything (V2X) communication (which may include vehicle-to-vehicle (V2V) communication, vehicle-to-infrastructure (V2I) communication, vehicle-to-network (V2N) communication, vehicle-to-pedestrian (V2P) communication, etc.), device-to-device (D2D) communication, etc., in which communication may be performed directly between user equipments. On this communication interface, a user equipment may perform wireless data transmission through a Sidelink (SL). Specifically, a terminal device may transmit and receive reference signals by utilizing an antenna panel installed thereon. In some scenarios, the reference signals may be used to implement functions such as positioning. Therefore, it is desirable to find a system and method that may effectively utilize antenna panels to transmit and receive reference signals to improve positioning performance.

### SUMMARY

The present disclosure proposes electronic devices and methods for sidelink communication in wireless communication systems. The present disclosure proposes indicating the position of an antenna panel transmitting a reference signal on a user equipment by using a time resource and/or frequency resource occupied by the reference signal, so that the positioning performance in the sidelink communication is improved.

According to a first aspect of the present disclosure, an electronic device for a first user equipment in a wireless communication system is provided. The electronic device comprises a processing circuit configured to cause the first user equipment to perform: receiving, through a first antenna panel installed on the first user equipment, a reference signal transmitted by a third antenna panel of a second user equipment installed thereon, wherein a time resource and/or frequency resource occupied by the reference signal are associated with a position of the third antenna panel on the second user equipment; and determining, based on an association relationship between the position of the third antenna panel on the second user equipment and one or more time resources and/or frequency resources and the time resource and/or frequency resource occupied by the reference signal, the position of the third antenna panel on the second user equipment.

Correspondingly, according to the first aspect of the present disclosure, a method for a first user equipment in a wireless communication system is further provided. The method comprises: receiving, through a first antenna panel installed on the first user equipment, a reference signal transmitted by a third antenna panel of a second user equipment installed thereon, wherein a time resource and/or frequency resource occupied by the reference signal being associated with a position of the third antenna panel on the second user equipment. In addition, the method further comprises determining, based on an association relationship between the position of the third antenna panel on the second user equipment and one or more time resources and/or frequency resources and the time resource and/or frequency resource occupied by the reference signal, the position of the third antenna panel on the second user equipment.

According to a second aspect of the present disclosure, an electronic device for a second user equipment in a wireless communication system is provided, the electronic device comprising a processing circuit configured to cause a first user equipment to perform: transmitting a reference signal to a first user equipment using a third antenna panel installed on the second user equipment, a time resource and/or frequency resource occupied by the reference signal being associated with a position of the third antenna panel on the second user equipment, so that the first user equipment determines the position of the third antenna panel on the second user equipment based on an association relationship between the position of the third antenna panel on the second user equipment and one or more time resources and/or frequency resources and the time resource and/or frequency resource occupied by the reference signal.

Correspondingly, according to the second aspect of the present disclosure, a method for a second user equipment in a wireless communication system is further provided. The method comprises: transmitting a reference signal to a first user equipment using a third antenna panel installed on the second user equipment, a time resource and/or frequency resource occupied by the reference signal being associated with a position of the third antenna panel on the second user equipment, so that the first user equipment determines the position of the third antenna panel on the second user equipment based on an association relationship between the position of the third antenna panel on the second user equipment and one or more time resources and/or frequency resources and the time resource and/or frequency resource occupied by the reference signal.

According to a third aspect of the present disclosure, there is provided a computer-readable storage medium having one or more executable instructions stored thereon, which, when executed by one or more processors of an electronic device, cause the electronic device to perform the methods according to various embodiments of the present disclosure.

According to a fourth aspect of the present disclosure, there is provided a computer program product comprising executable instructions, which, when executed by one or more processors of a computer, cause the computer to perform the methods according to various embodiments of the present disclosure.

The above summary is provided to summarize some exemplary embodiments in order to provide a basic understanding of various aspects of the subject matter described herein. Therefore, above features are merely examples and should not be construed as limiting the scope or spirit of the subject matter described herein in any way. Other features, aspects, and advantages of the subject matter described herein will become apparent from the Detailed Description described below in conjunction with the drawings.

### BRIEF DESCRIPTION OF THE DRAWINGS

A better understanding of the present disclosure may be obtained when the following detailed description of the embodiments is considered in conjunction with the accompanying drawings. The same or similar reference numerals are used throughout various drawings to denote the same or similar components. The accompanying drawings, along with the following detailed description, are incorporated in and constitute a part of this specification, to illustrate embodiments of the present disclosure and to explain the principles and advantages of the present disclosure. In which:

FIG. 1 illustrates an example scenario diagram of sidelink communication in a wireless communication system according to an embodiment of the present disclosure.

FIG. 2 illustrates an exemplary electronic device of a first user equipment for sidelink communication according to an embodiment of the disclosure.

FIG. 3 illustrates an exemplary electronic device of a second user equipment for sidelink communication according to an embodiment of the disclosure.

FIG. 4 illustrates a schematic diagram of the association relationship between a time-frequency resource of a reference signal and the position of an antenna panel according to an embodiment of the present disclosure.

FIG. 5 illustrates a schematic diagram of a first example of positioning in sidelink communication according to an embodiment of the present disclosure.

FIG. 6 illustrates a schematic diagram of a second example of positioning in sidelink communication according to an embodiment of the present disclosure.

FIG. 7 illustrates an interaction diagram between user equipments for sidelink communication according to an embodiment of the present disclosure.

FIG. 8 illustrates a flowchart of an example method for a first user equipment for sidelink communication according to an embodiment of the present disclosure.

FIG. 9 illustrates a flowchart of an example method for a second user equipment for sidelink communication according to an embodiment of the present disclosure.

FIG. 10 is a block diagram of an example structure of a personal computer as an information processing device that may be employed in an embodiment of the present disclosure;

FIG. 11 is a block diagram showing an example of a schematic configuration of a smartphone to which the technology of the present disclosure may be applied.

FIG. 12 is a block diagram showing an example of a schematic configuration of a vehicle navigation device to which the technology of the present disclosure may be applied.

Although the embodiments described in the present disclosure may be susceptible to various modifications and alternatives, specific embodiments thereof are illustrated by way of example in the accompanying drawings and described in detail herein. It should be understood, however, that the drawings and detailed description thereof are not intended to limit the embodiments to the particular forms disclosed, rather, it is intended to cover all modifications, equivalents and alternative falling within the spirit and scope of the claims.

### DETAILED DESCRIPTION

Representative applications of various aspects such as devices and methods according to the present disclosure are described below. The description of these examples is merely to add context and help understand the described embodiments. Therefore, it is clear to those skilled in the art that the embodiments described below may be practiced without some or all of the specific details. In other instances, well-known process steps have not been described in detail to avoid unnecessarily obscuring the described embodiments. Other applications are also possible, and the solutions of the present disclosure are not limited to these examples.

In the present disclosure, in order to facilitate the description of technical solutions involved in the embodiments, words such as “first” and “second” are used to distinguish the same or similar items with substantially the same functions and effects. It should be understood by those skilled in the art that the words such as “first” and “second” do not limit the quantity and execution order or priority order, etc., and “first” and “second” do not necessarily mean different.

Typically, a wireless communication system may include a network device and a user equipment, and the network device may provide communication services for one or more user equipments.

In the present disclosure, the term “network device” (or “base station”, “control device”) has the full breadth of its ordinary meaning and includes at least a wireless communication station that is part of a wireless communication system or a radio system to facilitate communication. As an example, the network device may be, for example, an eNB of the 4G communication standard, a gNB of the 5G communication standard, a remote radio head, a wireless access point, a drone control tower, or a communication apparatus that performs similar functions. In the present disclosure, “network device”, “base station” and “control device” may be used interchangeably, or the “network device” may be implemented as part of a “base station”. Hereinafter, the network device will be used as an example to describe application examples in detail in conjunction with the accompanying drawings.

In the present disclosure, the term “user equipment (UE)” or “terminal device” has the full breadth of its ordinary meaning and includes at least a terminal device that is part of a wireless communication system or a radio system to facilitate communication. As an example, the user equipment may be, for example, a terminal device such as a mobile phone, a laptop, a tablet, an in-vehicle device (e.g., a car, a bicycle, an electric car, an airplane, a ship, a train, a high-speed rail, etc.), a virtual reality device, a workshop device, a wireless device in an unmanned driving, a wearable device, a sensor, etc., or elements thereof. In the present disclosure, “user equipment” (hereinafter referred to as “UE” for short) and “terminal device” may be used interchangeably, or “user equipment” may be implemented as a part of “terminal device”.

In the present disclosure, the term “transmitting end” has the full breadth of its ordinary meaning, and generally indicates the side that transmits data in a communication system, which may be a network device/base station side or a user equipment/terminal device side. Similarly, the term “receiving end” has the full breadth of its ordinary meaning, and accordingly may indicate the side that receives data in a communication system, which may be a user equipment/terminal side or a network device/base station side. Hereinafter, an example in which both a transmitting end and a receiving end are user equipments is used for explanation, but this should not be understood as a limitation of the present disclosure. In addition, in the present disclosure, the same device may act as both a transmitting end and a receiving end.

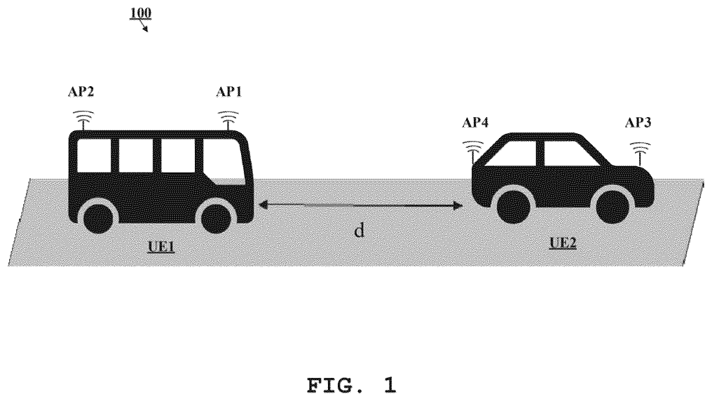

FIG. 1 illustrates an example scenario diagram of sidelink communication in a wireless communication system according to an embodiment of the present disclosure. It should be understood that FIG. 1 only illustrates one of a plurality of types and possible arrangements of wireless sidelink communication systems; features of the present disclosure may be implemented in any one of various systems as needed.

As shown in FIG. 1, the sidelink communication in a wireless communication system 100 involves communication between a plurality of user equipments. For ease of understanding and simplified description, two user equipments are shown in FIG. 1: a first user equipment (shown as “UE1” in FIG. 1) and a second user equipment (shown as “UE2” in FIG. 1). The first user equipment and the second user equipment may communicate directly without via a network device (i.e., both the transmitting end and the receiving end are user equipments), and the communication link between the two is called a sidelink. It should be understood that the first user equipment and the second user equipment may be devices of the same type or devices of different types.

In the sidelink communication, a user equipment may transmit and receive a reference signal through an antenna panel to achieve functions such as positioning. For example, in FIG. 1, each of user equipments (for example, the first user equipment or the second user equipment) may be installed with one or more antenna panels, and the one or more antenna panels may be installed at one or more positions on the user equipment. As an example, FIG. 1 shows a scenario in which UE1 and UE2 have two antenna panels respectively. Specifically, the first user equipment has a first antenna panel (shown as “AP1” in FIG. 1) and a second antenna panel (shown as “AP2” in FIG. 1), and the second user equipment has a third antenna panel (shown as “AP3” in FIG. 1) and a fourth antenna panel (shown as “AP4” in FIG. 1). For example, UE1 may receive reference signals transmitted from AP3 and AP4 of UE2 through AP1. For example, in some embodiments, the reference signal may be a synchronization reference signal or a positioning reference signal, which may be used to achieve functions such as positioning, for example, determining the relative position relationship between UE1 and UE2, etc.

It should be understood that the scenario in FIG. 1 is only an example, and there may be a greater number of user equipments in a communication system. It should also be understood that each of the user equipments may have a greater or lesser number of antenna panels. Although the antenna panels shown in FIG. 1 are located at the front and rear of the user equipments, respectively, in practice, the antenna panels may be installed at any position of the user equipments, including but not limited to the front (or head), rear (or tail), middle, top, bottom, left, right, etc. of the user equipments.

According to FIG. 1, when the first user equipment and the second user equipment cannot know from which position of the antenna panel the reference signal from the other party originates, the positioning performance may be greatly affected. For example, UE1, as a receiving end, may receive a reference signal from AP3 of UE2 through AP1, or it may receive a reference signal from AP4 of UE2 through AP1. If the size of UE2 itself is large, the positions of AP3 and AP4 on UE2 are likely to be far apart, thereby the distance between the two user equipments measured and estimated through the AP3 and AP4 is quite different. As an example, not a limitation, in a case that UE1 and UE2 are both vehicles, the normal driving distance d between the two user equipments may be more accurately measured or estimated by using AP1 of UE1 and AP4 of UE2 to transmit/receive the reference signal, otherwise a distance error of the vehicle body length will likely be generated. This distance error is particularly serious when the distance between the two user equipments is small, which reduces the accuracy of positioning.

In order to improve the positioning performance in sidelink communication, in the embodiment of the present disclosure, a time resource/frequency resource of a reference signal and the installation position of an antenna panel that transmits the reference signal on the transmitting end user equipment is associated (for example, mapped). As such, the receiving end user equipment that receives the reference signal may determine the position of the antenna panel that transmits the reference signal based on the predetermined association relationship and the time resource/frequency resource occupied by the reference signal, thereby performing respective operations or calculations to ensure more precise positioning performance.

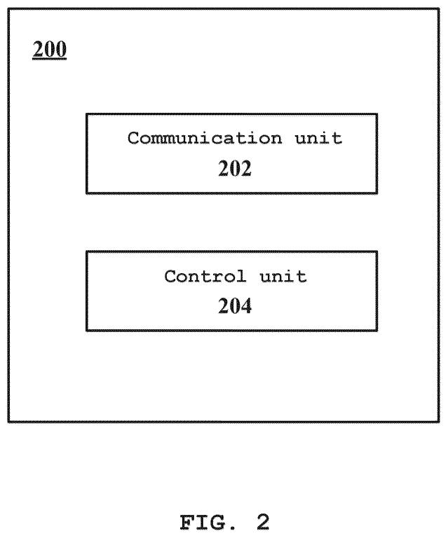

FIG. 2 illustrates an exemplary electronic device for a first user equipment in a wireless communication system according to an embodiment of the present disclosure. The electronic device 200 shown in FIG. 2 may include various units to implement various embodiments according to the present disclosure. In this example, the electronic device 200 includes a communication unit 202 and a control unit 204. In one implementation, the electronic device 200 is implemented as the first user equipment itself or a part thereof, or is implemented as a device related to the first user equipment or a part of the device. The various operations described below in conjunction with the first user equipment may be implemented by units 202 and 204 of the electronic device 200 or other possible units.

In an embodiment, the first user equipment may have one or more antenna panels installed (or attached) thereon. The communication unit 202 of the electronic device 200 of the first user equipment may receive a reference signal transmitted by a third antenna panel of the second user equipment installed thereon through the first antenna panel installed on the first user equipment, wherein a time resource and/or frequency resource occupied by the reference signal are associated with the position of the third antenna panel on the second user equipment. The control unit 204 of the electronic device may determine the position of the third antenna panel on the second user equipment based on the association relationship between the position of the third antenna panel on the second user equipment and one or more time resources and/or frequency resources and the time resource and/or frequency resource occupied by the above received reference signal.

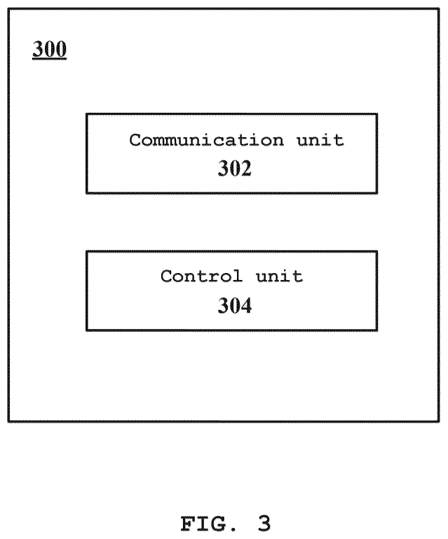

FIG. 3 illustrates an exemplary electronic device 300 for a second user equipment in a wireless communication system according to an embodiment of the present disclosure. The electronic device 300 shown in FIG. 3 may include various units to implement various embodiments according to the present disclosure. In this example, the electronic device 300 includes a communication unit 302 and a control unit 304. In one implementation, the electronic device 300 is implemented as the second user equipment itself or a part thereof, or is implemented as a device related to the second user equipment or a part of the device. The various operations described below in conjunction with the second user equipment may be implemented by units 302 and 304 of the electronic device 300 or other possible units.

In an embodiment, the second user equipment may have one or more antenna panels installed (or attached) thereon. The communication unit 302 of the electronic device 300 of the second user equipment may transmit a reference signal to the first user equipment through a third antenna panel installed on the second user equipment, wherein a time resource and/or frequency resource occupied by the reference signal are associated with the position of the third antenna panel on the second user equipment. The above operation may enable the first user equipment to determine the position of the third antenna panel on the second user equipment based on the association relationship between the position of the third antenna panel on the second user equipment and one or more time resources and/or frequency resources and the time resource and/or frequency resource occupied by the above transmitted reference signal.

It should be understood that the control unit 304 of the electronic device 300 may instruct the communication unit 302 to notify the first user equipment of the association relationship between the position of the third antenna panel on the second user equipment and one or more time resources and/or frequency resources in advance. Alternatively, the above association relationship may be determined by default, or may be predetermined by the network device and then notified to individual user equipments in the wireless communication system.

In some embodiments, the electronic devices 200 and 300 may be implemented at a chip level, or may be implemented at a device level by including other external components (e.g., radio links, antennas, etc.). For example, each electronic device may function as a communication device as a whole.

It should be noted that the above units are only logical modules divided according to specific functions they implement, and are not used to limit specific implementations, for example, they may be implemented in software, hardware or a combination of software and hardware. In practical implementations, the above units may be implemented as independent physical entities, or may also be implemented by a single entity (e.g., a processor (CPU or DSP, etc.), an integrated circuit, etc.). Wherein, the processing circuit may refer to various implementations of a digital circuitry, an analog circuitry or a mixed signal (a combination of analog and digital) circuitry that performs functions in a computing system. The processing circuit may include, for example, a circuit such as an Integrated Circuit (IC), an Application Specific Integrated Circuit (ASIC), parts or circuits of a separate processor core, the entire processor core, a separate processor, a programmable hardware device such as a field programmable gate array (FPGA), and/or a system including multiple processors.

### Association Relationship Between a Time-Frequency Resource And the Position of an Antenna Panel

According to an embodiment of the present disclosure, an association relationship (sometimes also referred to as a mapping relationship) is established between a time resource and/or frequency resource of a reference signal and the installation position of an antenna panel that transmits the reference signal on a transmitting end user equipment. In other words, the time resource and/or frequency resource occupied by the reference signal may indicate the specific position (or relative position) of the antenna panel that transmits the reference signal. Based on the association relationship, a receiving end user equipment that receives the reference signal may quickly and accurately determine the position of the antenna panel that transmits the reference signal on the transmitting end user equipment according to the time resource and/or frequency resource occupied by the reference signal.

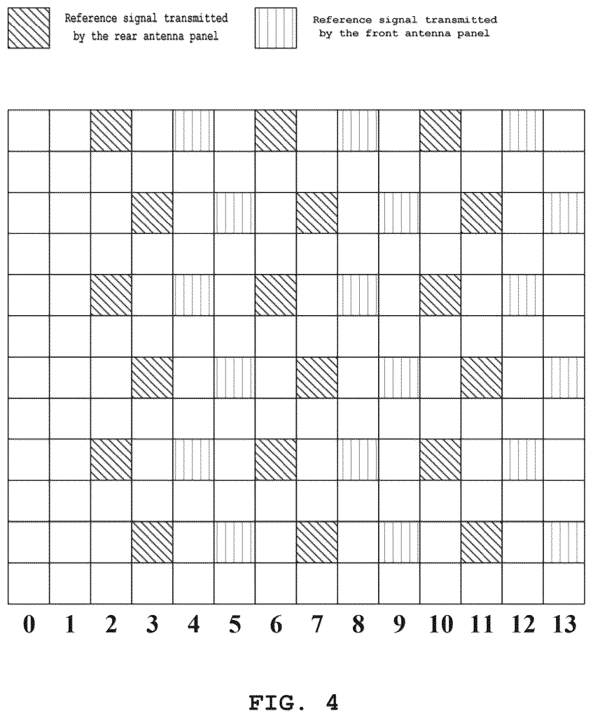

FIG. 4 illustrates an example diagram of an association relationship between a time-frequency resource of a reference signal and the position of an antenna panel according to an embodiment of the present disclosure. In this example, it is assumed that the user equipment has two antenna panels installed at the front and rear, respectively, which are referred to as the front antenna panel and the rear antenna panel in the figure. It should be understood that the words such as “front” and “rear” in the present disclosure only represent relative positions. For example, the normal moving direction of the user equipment may be defined as “front”, or the position generally considered to be the head of a user equipment may be defined as “front”. As an example, in a scenario where the user equipment is a vehicle, the front antenna panel may be installed on the front bumper of the vehicle, and the rear antenna panel may be installed on the rear bumper of the vehicle.

As shown in FIG. 4, one subframe in a wireless communication system may include 14 OFDM symbols. The horizontal axis in FIG. 4 may represent time resources, the vertical axis may represent frequency resources, and a small square represents one Resource Element (RE). A resource element may be regarded as the smallest unit of time resources and/or frequency resources (sometimes referred to as time-frequency resources herein), which corresponds to one OFDM symbol in the time domain and to one subcarrier in the frequency domain. In the example of FIG. 4, reference signals transmitted by the front antenna panel are associated with time-frequency resources represented by resource elements marked with vertical line shading, and reference signals transmitted by the rear antenna panel are associated with time-frequency resources represented by resource elements marked with diagonal line shading.

As mentioned above, the above association relationship (or mapping relationship) may be notified in advance by a transmitting end user equipment to a receiving end user equipment in the form of a mapping table or the like. Alternatively, such association relationship may also be determined by the system by default, or may be predetermined by the network device and then notified to individual user equipments. A notification message about the association relationship may be indicated via a physical layer message, or may be indicated via a higher layer message (such as a MAC layer message).

It should be understood that FIG. 4 only illustrates one example of the association relationship (or mapping relationship) between the position of the antenna panel and time-frequency resources of one or more reference signals. In practice, the transmitting end user equipment may have a greater or lesser number of antenna panels located at one or more positions, and the position of each antenna panel may be associated only with a time resource, only with a frequency resource, or with both of a time resource and a frequency resource.

Correspondingly, when a transmitting end user equipment transmits a reference signal, it needs to perform transmission by using a time-frequency resource corresponding to the position of an antenna panel on the user equipment according to the above association relationship. Optionally, the transmitting end user equipment may determine reference signals transmitted through antenna panels at different positions by using different Resource Sets. Optionally, the transmitting equipment may determine reference signals transmitted through antenna panels at different positions by using different Frequency Layers. After the transmitting end user equipment transmits a reference signal to the receiving end user equipment, the receiving end user equipment may be enabled to determine the position of the antenna panel that transmits the reference signal on the transmitting end user equipment based on the association relationship between position of the antenna panel and time-frequency resources, and the time-frequency resource occupied by the reference signal.

### Positioning in Sidelink Communications

As described with reference to FIG. 1, in wireless sidelink communication, appropriately selecting an antenna panel of a transmitting end user equipment and an antenna panel of a receiving end user equipment to transmit and receive a reference signal may improve positioning performance. Generally speaking, operations involved in positioning in sidelink communication include but are not limited to determining the relative position relationship of a plurality of user equipments, measuring and estimating distances among the plurality of user equipments, and inferring whether there is an abnormality in current positions or movements of plurality of 41 user equipments. Accordingly, two examples of positioning in sidelink communication will be described below for these operations respectively.

For ease of description and understanding, the technical solution of the present disclosure will be described hereinafter by taking the sidelink communication scenario in which both the first user equipment and the second user equipment are vehicles as an example. However, the present disclosure is not limited to communication between user equipments of this specific type, but may be applied to positioning scenarios in sidelink communication between a plurality of user equipments of various types.

### First Example of Positioning in Sidelink Communication

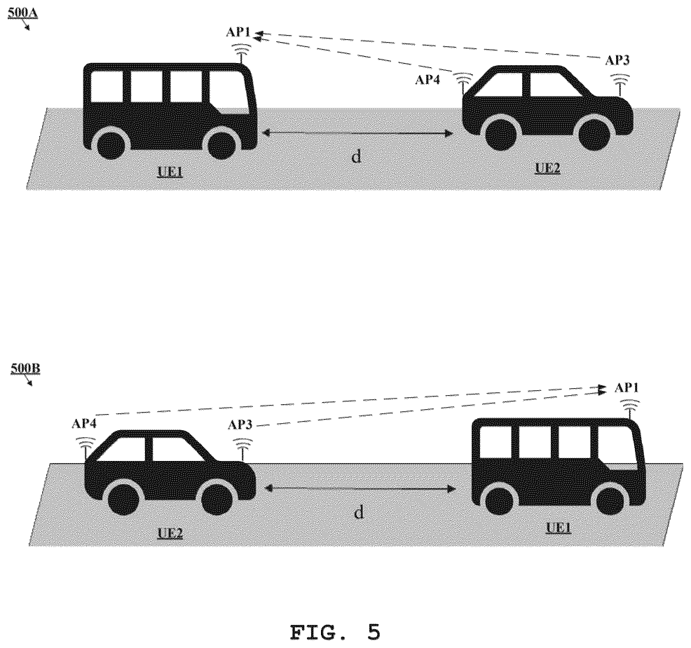

In a first example of sidelink positioning, the second user equipment mainly used as a transmitting end may have a plurality of antenna panels, and the first user equipment mainly used as a receiving end may have one antenna panel or only use one antenna panel among a plurality of antenna panels, thereby achieving a series of operations related to positioning. FIG. 5 illustrates a schematic diagram of the first example of positioning in sidelink communication according to an embodiment of the present disclosure.

In FIG. 5, the first user equipment is shown as UE1, on which at least a first antenna panel (shown as AP1) is installed; the second user equipment is shown as UE2, on which at least a third antenna panel (AP3) and a fourth antenna panel (AP4) are installed. Only as an example and not limitation, AP1 in the figure is located at the front of UE1, AP3 is located at the front of UE2, and AP4 is located at the rear of UE2.

According to an embodiment of the present disclosure, a time resource and/or frequency resource occupied by a reference signal transmitted by AP3 are associated with the position of AP3 on UE2 (e.g., the front), and a time resource and/or frequency resource occupied by the reference signal transmitted by AP4 are associated with the position of AP4 on UE2 (e.g., the rear). It should be appreciated that the association relationship between the position of AP3 on UE2 and one or more time resources and/or frequency resources and the association relationship between the position of AP4 on UE2 and one or more time resources and/or frequency resources may be determined by default, or may be notified to UE1 in advance by UE2. Generally speaking, one or more time resources and/or frequency resources associated with AP3 and one or more time resources and/or frequency resources associated with AP4 are independent of each other and do not overlap. Accordingly, UE1 may receive a reference signal transmitted by AP3 (or AP4) of UE2 through AP1, and may determine the position of AP3 (or AP4) on UE2 based on the association relationship between the position of the antenna panel and time-frequency resources, and the time-frequency resource occupied by the reference signal.

According to the first example of an embodiment of the present disclosure, the relative positions of the first user equipment (UE1) and the second user equipment (UE2) may be determined, for example, the relative position relationship may be determined.

As shown in FIG. 5, one method for determining the relative position between UE1 and UE2 may include: UE1 receiving a first reference signal transmitted by AP3 of UE2 through AP1, and UE1 receiving a second reference signal transmitted by AP4 of UE2 through AP1. Based on the reception strength of the first reference signal and the second reference signal, front-behind position relationship between UE1 and UE2 may be determined. Specifically, as shown in 500A, in a case that the strength of the first reference signal is less than the strength of the second reference signal, since UE1 may determine the position of the antenna panel that transmits the reference signal on UE2 according to the time resource and/or frequency resource of the received reference signal, it may be determined that UE1 is located behind UE2. Similarly, as shown in 500B, in a case that the strength of the first reference signal is greater than the strength of the second reference signal, UE1 may determine that it is located in front of UE2.

It should be understood that the strength of the reference signal referred to herein may include but is not limited to one or a combination of more than one of the following: reference signal received power (RSRP), reference signal received quality (RSRQ), signal to interference plus noise ratio (SINR) of reference signal, etc.

Alternatively, another method for determining the relative position between UE1 and UE2 may include using a satellite navigation positioning system (GPS) to roughly determine the front-behind position relationship of user equipments.

Further, based on the determined relative positions of UE1 and UE2, UE1 may receive a reference signal transmitted by one antenna panel in AP3 or AP4 of UE2 through AP1, for measuring the distance between UE1 and UE2. As an example, in a case that UE1 and UE2 are both vehicles driving normally, the distance (vehicle distance) d between the two generally refers to the distance between the front of the rear vehicle and the rear of the front vehicle. Specifically, as shown in 500A, in a case that it is determined that UE1 is located behind UE2, the distance d between the two user equipments may be measured and estimated by UE1 receiving a reference signal transmitted from AP4 of UE2 through AP1 (because AP4 is closer to UE1). Similarly, as shown in 500B, in a case that it is determined that UE1 is located in front of UE2, the distance d between the two user equipments may be measured and estimated by UE1 receiving a reference signal transmitted from AP3 of UE2 through AP1 (because AP3 is closer to UE1). It should be noted that in the latter case, since UE1 knows that AP1 is located at the front of itself, appropriate adjustments may be made when calculating the distance d, for example, subtracting its own equipment length (e.g., vehicle length).

It should be understood that the positions of the antenna panels in FIG. 5 are merely examples and are not intended to be limiting. For example, in practice, the first antenna panel may also be located in the middle position of the first user equipment, which in turn half of the length of the equipment itself may be subtracted when measuring and estimating the distance d between the first user equipment and the second user equipment. In some special scenarios, the first user equipment and the second user equipment may even each use only one antenna panel to measure the distance between the two user equipments. For example, if the first user equipment has determined that the antenna panel of the second user equipment is located in the middle position of the second user equipment according to the time-frequency resource of the received reference signal, and the antenna panel of the first user equipment also happens to be located in the middle position of the first user equipment, then the two user equipments may transmit reference signals by using only these two antenna panels for distance measurement and estimation.

It should also be understood that the method in the first example above may also be applied to determine the position relationship and spacing of a plurality of user equipments in other directions. For example, the relative left-right position relationship of a plurality of user equipments and the left-right spacing may be determined, wherein the first antenna panel may be located on the left or right side of the first user equipment, and the third antenna panel and the fourth antenna panel may be located on the left and right sides of the second user equipment.

Furthermore, in a scenario where a first user equipment (UE1) and a second user equipment (UE2) move in the same straight line, based on the determined relative positions of UEL and UE2, UE1 may determine whether there is any abnormality in the movement between UE1 and UE2 through the first distance from AP3 of UE2 and the second distance from AP4 of UE2 measured by AP1.

Specifically, as shown in 500A, in a case that it is determined that UE1 is located behind UE2, based on the first distance being less than the second distance, it may be determined that there is an abnormality in the movement between UE1 and UE2. For example, in an example where UE1 and UE2 are both vehicles, according to the traffic rule that two vehicles on the same lane should travel in the same direction, the first distance should be greater than the second distance. When an opposite size relationship occurs, the driving status of UE2 may be determined to be abnormal when UE1 ensures that its own driving is normal. For example, UE2 is likely to be driving in the opposite direction of UE1. In this scenario, UE1 may take remedial measures in a timely manner, including but not limited to changing its own driving lane, sending a warning to UE2 to let it change its driving direction, sending warnings to vehicles behind UE1 to avoid UE2, and so on. Similarly, as shown in 500B, in a case that it is determined that UE1 is located in front of UE2, based on the first distance being greater than the second distance, it may be determined that there is an abnormality in the movement between UE1 and UE2. When UE1 ensures that its own driving is normal, it may be determined that the driving status of UE2 is abnormal. For example, UE2 is likely to be driving in the reverse direction of UE1. In this scenario, UE1 may take remedial measures in a timely manner, including but not limited to changing its own driving lane, sending a warning to UE2 to let it change its driving direction, sending warnings to other vehicles behind UE1 to avoid UE2, and so on.

In summary, in the first example, the first user equipment may receive reference signals transmitted by a plurality of antenna panels of the second user equipment by using one antenna panel, and determine the positions of the plurality of antenna panels of the second user equipment based on time resources and/or frequency resources occupied by the reference signals. Based on this, the first user equipment may implement a variety of positioning functions, including determining the relative position between it and the second user equipment, determining the distance between it and the second user equipment, and determining whether there is any abnormality in the movement between it and the second user equipment.

### Second Example of Positioning in Sidelink Communication

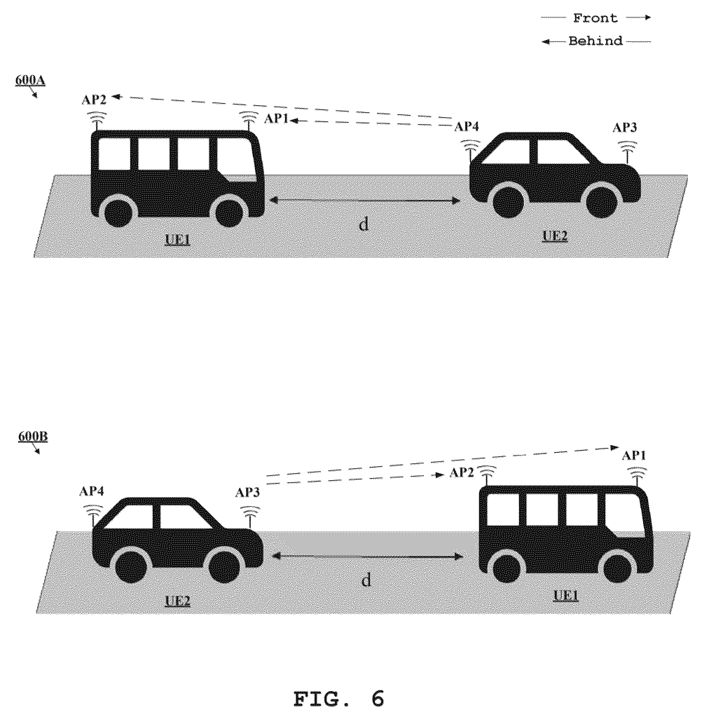

In a second example of sidelink positioning, the second user equipment mainly used as a transmitting end may have a plurality of antenna panels, and the first user equipment mainly used as a receiving end may have and utilize a plurality of antenna panels, thereby implementing a series of operations related to positioning. FIG. 6 illustrates a schematic diagram of a second example of positioning in sidelink communication according to an embodiment of the present disclosure.

In FIG. 6, the first user equipment is shown as UE1, on which at least a first antenna panel (shown as AP1) and a second antenna panel (shown as AP2) are installed; the second user equipment is shown as UE2, on which at least a third antenna panel (AP3) and a fourth antenna panel (AP4) are installed. Only as an example and not limitation, AP1 in the figure is located at the front of UE1, and AP2 is located at the rear of UE1; AP3 is located at the front of UE2, and AP4 is located at the rear of UE2. It may be seen that the second example, on the basis of the first example, enables the first user equipment to also use a plurality of antenna panels installed at a plurality of positions thereon to realize the positioning function in the sidelink communication.

Similar to the first example, in the second example, the time resource and/or frequency resource occupied by the reference signal transmitted by AP3 are associated with the position of AP3 on UE2 (e.g., the front) and the time resource and/or frequency resource occupied by the reference signal transmitted by AP4 are associated with the position of AP4 on UE2 (e.g., the rear). It should be appreciated that the association relationship between the position of AP3 on UE2 and one or more time resources and/or frequency resources and the association relationship between the position of AP4 on UE2 and one or more time resources and/or frequency resources may be determined by default, or may be notified to UE1 in advance by UE2. Generally speaking, one or more time resources and/or frequency resources associated with AP3 and one or more time resources and/or frequency resources associated with AP4 are independent of each other and do not overlap. Accordingly, UE1 may receive a reference signal transmitted by AP3 (or AP4)) of UE2 through AP1 (or AP2), and may determine the position of AP3 (or AP4) on UE2 based on the association relationship between the position of the antenna panel and time-frequency resources, and the time-frequency resource occupied by the reference signal.

According to the second example of the embodiment of the present disclosure, the relative positions of the first user equipment (UE1) and the second user equipment (UE2) may be determined, for example, the relative position relationship may be determined.

The two methods for determining the relative position between UE1 and UE2 have been described in the first example, wherein UE1 may use any antenna panel of AP1 or AP2 to perform the operations, which will not be repeated here again.

According to the second example, yet another method for determining the relative position between UE1 and UE2 may include UE1 receiving, through AP1, a first reference signal transmitted by one antenna panel of AP3 or AP4 of UE2, and UE1 receiving, through AP2, a second reference signal transmitted by the same antenna panel of AP3 or AP4 of UE2. Based on the reception strengths of the first reference signal and the second reference signal, the front-behind position relationship between UE1 and UE2 may be determined.

Specifically, as shown in 600A, UE1 may receive a first reference signal transmitted by AP4 of UE2 through AP1, and UE1 may receive a second reference signal transmitted by AP4 of UE2 through AP2 (alternatively, the first reference signal and the second reference signal may be transmitted by AP3 of UE2). In a case that the strength of the first reference signal is greater than the strength of the second reference signal, since UE1 knows the installation positions of AP1 and AP2 on itself, it may be determined that UE1 is located behind UE2. Similarly, as shown in 600B, UE1 may receive a first reference signal transmitted by AP3 of UE2 through AP1, and UE1 may receive a second reference signal transmitted by AP3 of UE2 through AP2 (alternatively, the first reference signal and the second reference signal may be transmitted by AP4 of UE2). In a case that the strength of the first reference signal is less than the strength of the second reference signal, UE1 may determine that it is located in front of UE2.

It should be understood that the strength of the reference signal referred to herein may include but is not limited to one or a combination of more than one of the following: reference signal received power (RSRP), reference signal received quality (RSRQ), signal to interference plus noise ratio (SINR) of reference signal, etc.

Further, based on the determined relative positions of UE1 and UE2, UE1 may receive a reference signal transmitted by one antenna panel in AP3 or AP4 of UE2 through one antenna panel in AP1 or AP2, for measuring the distance between UE1 and UE2. As an example, in a case that UE1 and UE2 are both vehicles driving normally, the distance (vehicle distance) d between the two generally refers to the distance between the front of the rear vehicle and the rear of the front vehicle. Thus, the reference signal transmitted by the two closest antenna panels on UEL and UE2 may be selected to measure or estimate the distance. Specifically, as shown in 600A, in a case that it is determined that UE1 is located behind UE2, the distance d between the two user equipments may be measured and estimated by UE1 receiving a reference signal transmitted from AP4 of UE2 through AP1. This is because UE1 knows that AP1 is located at the front of it, and according to the received reference signal transmitted by AP4, it is known to be located behind UE2, and the two antenna panels are closest. Similarly, as shown in 600B, in a case that it is determined that UE1 is located in front of UE2, the distance d between the two user equipments may be measured and estimated by UE1 receiving a reference signal transmitted from AP3 of UE2 through AP2. It should be noted that, compared with the first example, such method for measuring the distance between user equipments in the second example generally does not require additional adjustments.

It should be understood that the positions of the antenna panels in FIG. 6 are merely examples and are not intended to be limiting. For example, the method in the second example above may also be applied to determining the relative left-right position relationship of a plurality of user equipments and determining the left-right spacing, wherein the first antenna panel and the second antenna panel may be located on the left and right sides of the first user equipment, and the third antenna panel and the fourth antenna panel may be located on the left and right sides of the second user equipment.

It should also be understood that the second example mainly sets forth the positioning function that the first user equipment can achieve by using a plurality of antenna panels installed at a plurality of locations thereon. If the first user equipment only uses one antenna panel among the plurality of antenna panels, the method set forth in the first example may be used to achieve various positioning operations.

Those skilled in the art should appreciated that, in a case that the first user equipment and the second user equipment each have a plurality of antenna panels, the functions of the two may be interchanged. In other words, the first user equipment may also be mainly used as a transmitting end user equipment, and the second user equipment may also be mainly used as a receiving end equipment. For example, a time resource and/or frequency resource occupied by a reference signal transmitted by AP1 are associated with the position of AP1 on UE1 (for example, the front), and a time resource and/or frequency resource occupied by a reference signal transmitted by AP2 are associated with the position of AP2 on UE1 (for example, the rear). This association relationship may be determined by default, or may be notified to UE2 in advance by UE1. Based on this, UE2 may use the methods performed by UE1 in the above examples to implement a series of operations related to positioning.

### Distance Measurement and Estimation Methods

In the first and second examples of positioning in wireless sidelink communication, both involve using antenna panels of the second user equipment and antenna panels of the first user equipment to measure and estimate the distance between the two. Two feasible methods for distance measurement and estimation will be introduced below.

According to some embodiments of the present disclosure, the reference signal received power (RSRP) may be used to perform distance measurement and estimation. Specifically, the distance between the antenna panel i of a transmitting end user equipment and the antenna panel j of a receiving end user equipment may be calculated by the power path loss of a reference signal transmitted from the antenna panel i to the antenna panel j. As an example, the two have the following relationship:

$${PL}_{i , j} = 32.4 + 20 {lgD}_{i , j} + 20 lgf$$

In the above formula, PL_{i,j} represents the path loss of a reference signal transmitted between antenna panel i and antenna panel j, D_{i,j} represents the distance between the antenna panel i of the transmitting end user equipment and the antenna panel j of the receiving end user equipment, and f represents the frequency (unit: MHz). Therefore, using the above relationship formula, the distance between the two antenna panels of the two user equipments may be calculated through the received power loss of the reference signal, and then, after appropriate adjustment, the distance between the two user equipments may be obtained. Similarly, the distance between user equipments may be measured and estimated by using methods such as those related to reference signal received quality (RSRQ).

According to some other embodiments of the present disclosure, the Round Trip Time (RTT) of a reference signal may be used to perform distance measurement and estimation. Specifically, the first user equipment may transmit a first positioning reference signal to the second user equipment, and the second user equipment may transmit a second positioning reference signal to the first user equipment. The first user equipment records the time difference

$$Δ {T}_{1} = {t}_{1}^{Rx} - {t}_{1}^{Tx}$$

between receiving the second positioning reference signal and transmitting the first positioning reference signal as a first positioning information. The second user equipment sends the time difference

$${T}_{2} = {t}_{2}^{Rx} - {t}_{2}^{Tx}$$

between receiving the first positioning reference signal and transmitting the second positioning reference signal as a second positioning information to the first user equipment. Based on this, the first user equipment sums ΔT₁ in the first positioning information with ΔT₂ in the second positioning information to obtain the round trip time RTT=ΔT₁+ΔT₂ of the signal. Thus, according to the electromagnetic signal propagation formula, the distance d=c·RTT/2 between the two user equipments may be obtained, in which, c may be the speed of light, 3×10⁸ m/s. It should be noted that in the above process, the first user equipment uses the same antenna panel to transmit the first positioning reference signal and receive the second positioning reference signal. Similarly, the second user equipment uses the same antenna panel to transmit the second positioning reference signal and receive the first positioning reference signal. In other words, the above distance is the distance between the antenna panels on the two equipments, and then the distance may be appropriately adjusted according to the positions of the antenna panels to obtain the distance between the two equipments. It should be understood that in the RTT ranging method, the same user equipment is used as both a receiving end equipment and a transmitting end equipment.

### Information Interaction

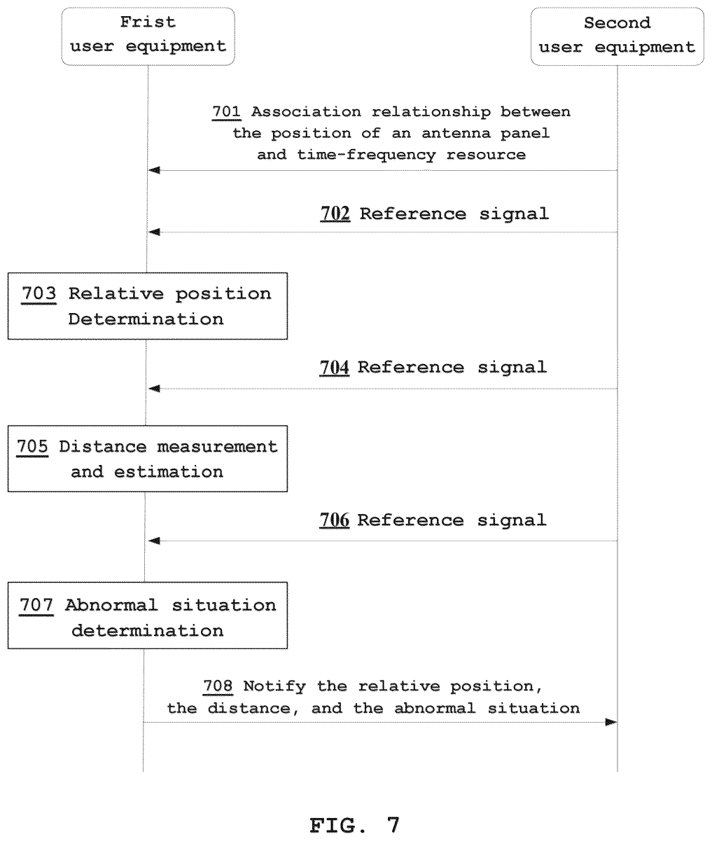

The schematic configuration and operation flow of the first user equipment (mainly used as a receiving end user equipment) and the second user equipment (mainly used as a transmitting end user equipment) according to the embodiments of the present disclosure have been described above in conjunction with the accompanying drawings. A communication interaction diagram for positioning in the sidelink communication in the wireless communication system according to an embodiment of the present disclosure will be described below with reference to FIG. 7.

As shown in FIG. 7, at 701, the second user equipment notifies the first user equipment in advance of the association relationship between the positions of one or more antenna panels on the second user equipment and one or more time resources/frequency resources (also referred to as time-frequency resources herein). In the present disclosure, particular attention is paid to the scenario where the user equipments have a plurality of antenna panels, so the following interaction flow is described by taking the first user equipment and the second user equipment each having antenna panels located at two different positions as an example. As mentioned above, time-frequency resources associated with two different antenna panels on a user equipment may be independent of each other and do not overlap. Alternatively, the above association relationship may be determined by default, or may be predetermined by the network device and then notified to individual user equipments. Based on the above association relationship, the first user equipment may determine the position of an antenna panel that transmits a reference signal on the second user equipment according to a time-frequency resource occupied by the received reference signal, thereby performing a series of operations related to positioning to improve positioning performance. Additionally and optionally, the second user equipment may also send a message in advance indicating that it has a plurality of antenna panels to the first user equipment, so that the first user equipment may flexibly configure the reception of reference signals transmitted by the plurality of antenna panels for operations related to positioning.

At 702, the first user equipment may receive a reference signal from the second user equipment to determine the relative position of the first user equipment and the second user equipment (e.g., front-behind position relationship, left-right position relationship, up-down position relationship, etc.) (703). According to some embodiments of the present disclosure, the first user equipment may receive reference signals transmitted from two antenna panels of the second user equipment through one antenna panel installed thereon, and determine the relative positions of the first user equipment and the second user equipment according to the strengths of these reference signals and the positions of the respective antenna panels that transmitted the reference signals (e.g., refer to the first example and the operations described in FIG. 5 in the present disclosure). According to some other embodiments of the present disclosure, the first user equipment may receive reference signals transmitted from the same antenna panel of the second user equipment through two antenna panels installed thereon, and determine the relative positions of the first user equipment and the second user equipment according to the position of its own antenna panel and the strengths of the received respective reference signals (e.g., refer to the second example and the operations described in FIG. 6 in the present disclosure). Optionally, the satellite navigation positioning system (GPS) may also be used to roughly determine the position relationship between the first user equipment and the second user equipment.

At 704, the first user equipment receives a reference signal from the second user equipment for measuring and estimating the distance between the first user equipment and the second user equipment (705). It should be understood that the distance between the two user equipments herein refers to the distance between the closest parts of the two user equipments. For example, in the example where the first user equipment and the second user equipment are both vehicles, the distance between the two may be the distance between the front of the rear vehicle and the rear of the front vehicle, or the distance between the right side of the left vehicle and the left side of the right vehicle. According to some embodiments of the present disclosure, the first user equipment may receive a reference signal transmitted from one of the two antenna panels of the second user equipment closest to the first user equipment (the closest antenna panel may be determined based on the determined relative positions of the two user equipments) through one antenna panel installed thereon, for determining the distance between the first user equipment and the second user equipment. It should be understood that in this case, it may be necessary to make appropriate adjustments to the estimated distance as needed to remove the influence of the position of the antenna panel on the first user equipment on the distance estimation (for example, refer to the first example and the operations described in FIG. 5 in the present disclosure). According to some other embodiments of the present disclosure, a first user equipment may receive a reference signal transmitted from one of the two antenna panels of the second user equipment closest to the first user equipment (the closest antenna panel may be determined based on the determined relative positions of the two user equipments) through one of two antenna panels installed thereon that is closest to the second user equipment for determining the distance between the first user equipment and the second user equipment (for example, refer to the second example and the operations described in FIG. 6 in the present disclosure).

Those skilled in the art should appreciated that the above distance measurement and estimation may be performed by using methods such as reference signal received power (RSRP), reference signal received quality (RSRQ), etc. Alternatively, the distance measurement and estimation may also be performed by using the reference signal round trip time (RTT) method. In the RTT method, in addition to receiving a positioning reference signal from the second user equipment, the first user equipment also needs to transmit a positioning reference signal to the second user equipment.

At 706, the first user equipment receives a reference signal from the second user equipment to determine whether there is an abnormality in the position or movement between the first user equipment and the second user equipment (707). This operation is mainly aimed at a scenario where the first user equipment and the second user equipment move in the same straight line. As an example, the first user equipment measures distances between the same antenna panel of its own and two antenna panels of the second user equipment (for example, including a first distance and a second distance). Based on the determined relative position of the first user equipment and the second user equipment, the first user equipment compares the magnitude of the first distance and the second distance. If the magnitude relationship does not match magnitude relationship under normal movement situation, the first user equipment may determine that the movement between the first user equipment and the second user equipment is abnormal. For example, while ensuring that its own movement is normal, the first user equipment may determine that the movement of the second user equipment is abnormal.

Accordingly, at 708, the first user equipment may notify the second user equipment of the relative position to the second user equipment, the distance to the second user equipment, and the abnormal movement of the second user equipment determined as described above. For example, in the event of abnormal movement, the first user equipment itself may change the movement lane and warn the second user equipment at the same time, so that it may return to normal as soon as possible.

It should be noted that the interaction diagram in FIG. 7 is merely an example and is not intended to be limiting. The diagram may include more or fewer steps, and the steps may also be performed in an order different from the order of the steps depicted in the diagram. As an example, 708 may be divided into three steps, i.e., in the three steps, the first user equipment notifies the second user equipment of information about the relative position, the distance estimation, and the abnormal movement situation, respectively. Alternatively, the three steps divided above may be performed immediately after 703, 705, and 707, respectively.

It should be understood that, symmetrically, the interaction in FIG. 7 is also applicable in a scenario where the second user equipment is mainly used as a receiving end and the first user equipment is mainly used as a transmitting end. In other words, in this scenario, operations similar to the operations at 701, 702, 704 and 706 (for example, assuming that they are labelled as 701′, 702′, 704′ and 706′) may be transmitted by the second user equipment to the first user equipment, and operations similar to the operations at 703, 705 and 707 (for example, assuming that they are labelled as 703′, 705′ and 707′) may be performed by the second user equipment. It should also be understood that the operations of 701′-707′ may be performed after the operations of 701-707, or may be performed in a time-interleaving manner with the operations of 701-707, and in this case step 708 may be omitted.

For sidelink communications in wireless communication systems, the present disclosure proposes a method for associating the position of an antenna panel on a user equipment with one or more time resources and/or frequency resources, so that a receiving end user equipment can determine the position of an antenna panel that transmits a reference signal on a transmitting end user equipment according to a time resource and/or frequency resource occupied by the reference signal. Further, based on this concept, the present disclosure proposes a method for operations related to positioning in sidelink communications, including determining relative positions of a plurality of user equipments, determining distances among a plurality of user equipments, determining whether there are abnormalities in movements between a plurality of user equipments, etc.

According to the inventive concept and technical solution proposed in the present disclosure, beneficial technical effects may be achieved. On one hand, the present disclosure may select reference signals transmitted by antenna panels on two user equipments that closer to each other to measure and estimate the distance, thereby improving the estimation accuracy of the distance between the two user equipments. On the other hand, the present disclosure can conveniently determine whether there is abnormal movement of equipments based on the determined relative positions of two user equipments and by comparing the measured magnitude of distances to antenna panels at different positions on a transmitting end equipment. This can effectively improve safety performance in scenarios such as in-vehicle user equipment communication, for example, allowing vehicles to change driving lanes in time and issue warnings to abnormal vehicles. On yet another hand, the installation position (or attachment position) of an antenna panel that transmits a reference signal on a user equipment is implicitly indicated by the time resource and/or frequency resource occupied by the reference signal, which can greatly save message overhead. On further another hand, a user equipment may know whether the other user equipment is a user equipment with a plurality of antenna panels according to the received association relationship, so that the received reference signal may be flexibly used to perform positioning operations.

### Exemplary Methods

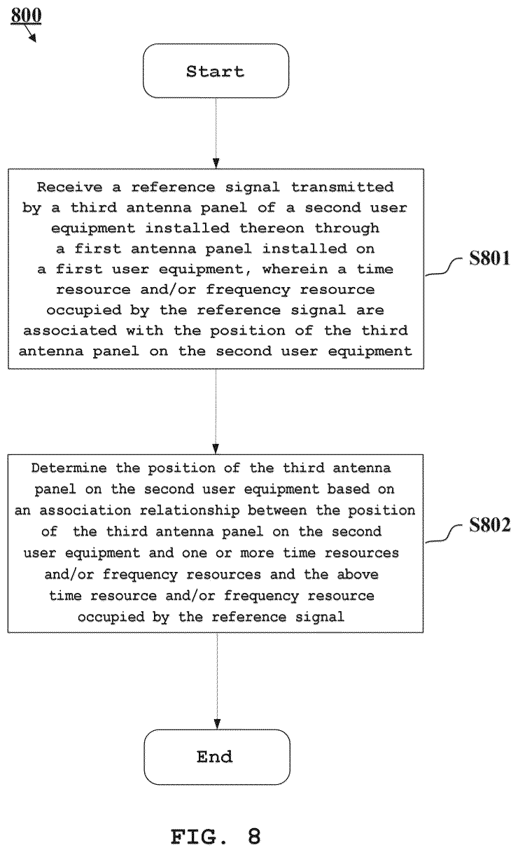

FIG. 8 illustrates a flowchart of an example method 800 for a first user equipment in a wireless communication system according to an embodiment of the present disclosure. The method may be performed by a first user equipment (e.g., a user equipment mainly used as a receiving end) (or more specifically, an electronic device 200) in sidelink communication. As shown in FIG. 8, the method 800 may include receiving a reference signal transmitted by a third antenna panel of a second user equipment (e.g., a user equipment mainly used as a transmitting end) installed thereon through a first antenna panel installed on a first user equipment, wherein a time resource and/or frequency resource occupied by the reference signal are associated with the position of the third antenna panel on the second user equipment (block S801). At block S802, the first user equipment may determine the position of the third antenna panel on the second user equipment based on the association relationship between the position of the third antenna panel on the second user equipment and one or more time resources and/or frequency resources and the above time resource and/or frequency resource occupied by the reference signal. The detailed example operations of the method may refer to the above description of the operations of the first user equipment (or more specifically, the electronic device 200), which will not be repeated here again.

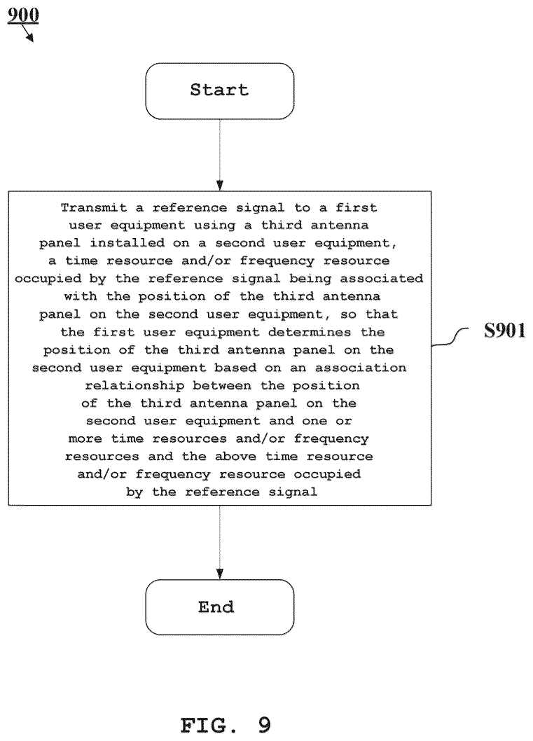

FIG. 9 illustrates a flowchart of an example method 900 for a second user equipment in a wireless communication system according to an embodiment of the present disclosure. The method may be performed by a second user equipment (e.g., a user equipment mainly used as a transmitting end) (or more specifically, an electronic device 500) in sidelink communication. As shown in FIG. 9, the method 900 may include transmitting a reference signal to a first user equipment (e.g., a user equipment mainly used as a receiving end) using a third antenna panel installed on a second user equipment, a time resource and/or frequency resource occupied by the reference signal being associated with the position of the third antenna panel on the second user equipment, so that the first user equipment determines the position of the third antenna panel on the second user equipment based on the association relationship between the position of the third antenna panel on the second user equipment and one or more time resources and/or frequency resources and the above time resource and/or frequency resource occupied by the reference signal, as shown in block S901. The detailed example operations of the method may refer to the above description of the operations of the second user equipment (or more specifically, the electronic device 300), which will not be repeated here again.

The solution of the present disclosure may be implemented in the following example manner.

Clause 1. An electronic device for a first user equipment in a wireless communication system, the electronic device comprising a processing circuit configured to cause the first user equipment to perform:
receiving, through a first antenna panel installed on the first user equipment, a reference signal transmitted by a third antenna panel of a second user equipment installed thereon, wherein a time resource and/or frequency resource occupied by the reference signal are associated with a position of the third antenna panel on the second user equipment; and
determining, based on the association relationship between the position of the third antenna panel on the second user equipment and one or more time resources and/or frequency resources and the time resource and/or frequency resource occupied by the reference signal, the position of the third antenna panel on the second user equipment.

Clause 2. The electronic device according to Clause 1, wherein:
the second user equipment further comprises a fourth antenna panel installed thereon, a time resource and/or frequency resource occupied by a reference signal transmitted by the fourth antenna panel being associated with a position of the fourth antenna panel on the second user equipment; and
the association relationship between the position of the third antenna panel on the second user equipment and one or more time resources and/or frequency resources and the association relationship between the position of the fourth antenna panel on the second user equipment and one or more time resources and/or frequency resources are determined by default, or are notified in advance to the first user equipment by the second user equipment, wherein the one or more time resources and/or frequency resources associated with the third antenna panel and the one or more time resources and/or frequency resources associated with the fourth antenna panel are independent of each other.

Clause 3. The electronic device according to Clause 1 or 2, wherein the reference signal comprises a positioning reference signal or a synchronization reference signal.

Clause 4. The electronic device according to Clause 2, wherein:
the third antenna panel is located at the front of the second user equipment, and the fourth antenna panel is located at the rear of the second user equipment.

Clause 5. The electronic device according to Clause 4, the processing circuit is further configured to cause the first user equipment to perform:
determining a relative position of the first user equipment and the second user equipment.

Clause 6. The electronic device according to Clause 5, wherein determining the relative position of the first user equipment and the second user equipment comprises:
receiving, through the first antenna panel, a first reference signal transmitted by the third antenna panel of the second user equipment;
receiving, through the first antenna panel, a second reference signal transmitted by the fourth antenna panel of the second user equipment; and
in response to the strength of the first reference signal being greater than the strength of the second reference signal, determining that the first user equipment is located in front of the second user equipment; or in response to the strength of the first reference signal being less than the strength of the second reference signal, determining that the first user equipment is located behind the second user equipment.

Clause 7. The electronic device according to Clause 5, the processing circuit is further configured to cause the first user equipment to perform:
based on the relative position of the first user equipment and the second user equipment, receiving, through the first antenna panel, a reference signal transmitted by one of the third antenna panel or the fourth antenna panel, for measuring the distance between the first user equipment and the second user equipment.

Clause 8. The electronic device according to Clause 5, the processing circuit is further configured to, in response to the first user equipment and the second user equipment moving in the same straight line:
based on the relative position of the first user equipment and the second user equipment, and based on a measured first distance from the third antenna panel of the second user equipment and a measured second distance from the fourth antenna panel of the second user equipment by the first antenna panel, determine whether there is an abnormality in the movement between the first user equipment and the second user equipment.

Clause 9. The electronic device according to Clause 8, wherein determining whether there is an abnormality in the movement between the first user equipment and the second user equipment comprises:
in response to the first user equipment being located in front of the second user equipment, based on the first distance being greater than the second distance, determining that there is an abnormality in the movement between the first user equipment and the second user equipment; or
in response to the first user equipment being located behind the second user equipment, based on the first distance being less than the second distance, determining that there is an abnormality in the movement between the first user equipment and the second user equipment.

Clause 10. The electronic device according to Clause 4, wherein:
the first user equipment further comprises a second antenna panel installed thereon, and
the first antenna panel is located at the front of the first user equipment, and the second antenna panel is located at the rear of the first user equipment.

Clause 11. The electronic device according to Clause 10, the processing circuit is further configured to cause the first user equipment to perform:
determining a relative position of the first user equipment and the second user equipment.

Clause 12. The electronic device according to Clause 11, wherein determining the relative position of the first user equipment and the second user equipment comprises:
receiving, through the first antenna panel, a first reference signal transmitted by one of the third antenna panel or the fourth antenna panel of the second user equipment;
receiving, through the second antenna panel, a second reference signal transmitted by the one of the third antenna panel or the fourth antenna panel of the second user equipment; and
in response to the strength of the first reference signal being greater than the strength of the second reference signal, determining that the first user equipment is located behind the second user equipment; or in response to the strength of the first reference signal being less than the strength of the second reference signal, determining that the first user equipment is located in front of the second user equipment.

Clause 13. The electronic device according to Clause 11, the processing circuit is further configured to cause the first user equipment to perform:
based on the relative position of the first user equipment and the second user equipment, receiving, through one of the first antenna panel or the second antenna panel, a reference signal transmitted by one of the third antenna panel or the fourth antenna panel, for measuring the distance between the first user equipment and the second user equipment.

Clause 14. The electronic device according to Clause 13, wherein:
in response to the first user equipment being located in front of the second user equipment, receiving, through the second antenna panel, a reference signal transmitted by the third antenna panel, for measuring the distance between the first user equipment and the second user equipment; or
in response to the first user equipment being located behind the second user equipment, receiving, through the first antenna panel, a reference signal transmitted by the fourth antenna panel, for measuring the distance between the first user equipment and the second user equipment.

Clause 15. The electronic device according to Clause 1, wherein the first user equipment is a vehicle and the second user equipment is a vehicle.

Clause 16. An electronic device for a second user equipment in a wireless communication system, the electronic device comprising a processing circuit configured to cause the second user equipment to perform:
transmitting a reference signal to a first user equipment using a third antenna panel installed on the second user equipment, a time resource and/or frequency resource occupied by the reference signal being associated with a position of the third antenna panel on the second user equipment, so that the first user equipment determines the position of the third antenna panel on the second user equipment based on the association relationship between the position of the third antenna panel on the second user equipment and one or more time resources and/or frequency resources and the time resource and/or frequency resource occupied by the reference signal.

Clause 17. The electronic device according to Clause 16, wherein:
the second user equipment further comprises a fourth antenna panel installed thereon, a time resource and/or frequency resource occupied by the reference signal transmitted by the fourth antenna panel being associated with the position of the fourth antenna panel on the second user equipment; and
the association relationship between the position of the third antenna panel on the second user equipment and one or more time resources and/or frequency resources, and the association relationship between the position of the fourth antenna panel on the second user equipment and one or more time resources and/or frequency resources are determined by default, or are notified in advance to the first user equipment by the second user equipment, wherein the one or more time resources and/or frequency resources associated with the third antenna panel and the one or more time resources and/or frequency resources associated with the fourth antenna panel are independent of each other.

Clause 18. A method for a first user equipment in a wireless communication system, the method comprising:
receiving, through a first antenna panel installed on the first user equipment, a reference signal transmitted by a third antenna panel of a second user equipment installed thereon, wherein a time resource and/or frequency resource occupied by the reference signal being associated with a position of the third antenna panel on the second user equipment; and
determining, based on an association relationship between the position of the third antenna panel on the second user equipment and one or more time resources and/or frequency resources and the time resource and/or frequency resource occupied by the reference signal, the position of the third antenna panel on the second user equipment.

Clause 19. A method for a second user equipment in a wireless communication system, the method comprising:
transmitting a reference signal to a first user equipment using a third antenna panel installed on the second user equipment, a time resource and/or frequency resource occupied by the reference signal being associated with a position of the third antenna panel on the second user equipment, so that the first user equipment determines the position of the third antenna panel on the second user equipment based on an association relationship between the position of the third antenna panel on the second user equipment and one or more time resources and/or frequency resources and the time resource and/or frequency resource occupied by the reference signal.

Clause 20. A computer-readable storage medium having one or more executable instructions stored thereon, which, when executed by one or more processors of an electronic device, cause the electronic device to perform the method according to Clause 18 or 19.

Clause 21. A computer program product comprising executable instructions which, when executed by one or more processors of a computer, cause the computer to perform the method according to Clause 18 or 19.

It should be noted that the application examples described above are merely exemplary. The embodiments of the present disclosure may also be executed in any other appropriate manner in the above application examples, and the advantageous effects obtained by the embodiments of the present disclosure may still be achieved. Moreover, the embodiments of the present disclosure may also be applied to other similar application instances, and the advantageous effects obtained by the embodiments of the present disclosure may still be achieved.

It should be understood that machine-executable instructions in a machine-readable storage medium or program product according to embodiments of the present disclosure may be configured to perform operations corresponding to the device and method embodiments described above. When referring to the above device and method embodiments, the embodiments of the machine-readable storage medium or program product will be apparent to those skilled in the art, and therefore description thereof will not be repeated. Machine-readable storage media and program products for carrying or including the above machine-executable instructions also fall within the scope of the present disclosure. Such storage media may include, but are not limited to, floppy disks, optical disks, magneto-optical disks, memory cards, memory sticks, and the like.

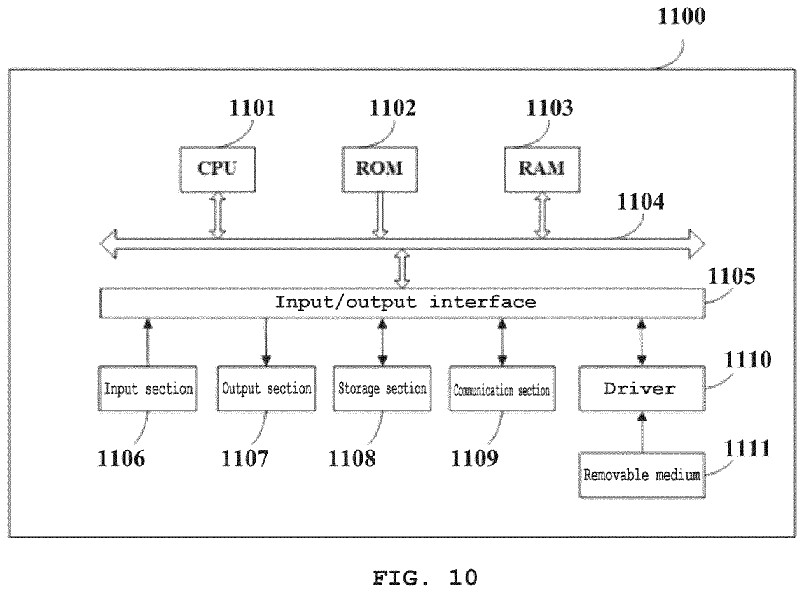

In addition, it should be understood that the above series of processes and devices may also be implemented by software and/or firmware. In a case of being implemented by software and/or firmware, a program constituting the software is installed from a storage medium or a network to a computer having a dedicated hardware structure, such as a general-purpose personal computer 1100 shown in FIG. 10, which, when is installed with various programs, may perform various functions and so on. FIG. 10 is a block diagram showing an example structure of a personal computer as an information processing device that may be employed in an embodiment of the present disclosure. In one example, the personal computer may correspond to the above exemplary terminal device according to the present disclosure.

In FIG. 10, a central processing unit (CPU) 1101 executes various processes according to a program stored in a read only memory (ROM) 1102 or a program loaded from a storage section 1108 to a random access memory (RAM) 1103. In the RAM 1103, data required when the CPU 1101 executes various processes and the like is also stored as necessary.

The CPU 1101, the ROM 1102, and the RAM 1103 are connected to each other via a bus 1104. Input/output interface 1105 is also connected to the bus 1104.

The following components are connected to the input/output interface 1105: an input section 1106 including a keyboard, mouse, etc.; an output section 1107 including a display such as a cathode ray tube (CRT), a liquid crystal display (LCD), etc., and a speaker, etc.; a storage section 1108 including a hard disk etc.; and a communication section 1109, including a network interface card such as a LAN card, a modem, etc. The communication section 1109 performs communication processing via a network such as the Internet.

The driver 1110 is also connected to the input/output interface 1105 as needed. A removable medium 1111 such as a magnetic disk, an optical disk, a magneto-optical disk, a semiconductor memory and the like is mounted on the drive 1110 as needed, so that a computer program read therefrom is installed into the storage section 1108 as needed.

In a case that the above series of processing is implemented by software, a program constituting the software is installed from a network such as the Internet or a storage medium such as a removable medium 1111.

It should be understood by those skilled in the art that such a storage medium is not limited to the removable medium 1111 shown in FIG. 10 in which a program is stored and distributed separately from the device to provide the program to the user. Examples of the removable medium 1111 include magnetic disks (including floppy disks (registered trademark)), optical disks (including compact disk read only memory (CD-ROM) and digital versatile disks (DVD)), magneto-optical disks (including mini discs (MD) (registered trademark)) and semiconductor memories. Alternatively, the storage medium may be the ROM 1102, a hard disk included in the storage section 1108, or the like, in which programs are stored and distributed to users together with the devices containing them.

The techniques of the present disclosure may be applied to various products.

For example, the electronic devices 200 and 300 according to the embodiments of the present disclosure may be implemented as or included in various electronic devices/terminal devices, while the methods shown in FIG. 8 and/or FIG. 9 may also be performed by various electronic devices/terminal devices.

For example, the terminal devices mentioned in the present disclosure are also referred to as user equipments in some examples, and may be implemented as mobile terminals (such as smart phones, tablet personal computers (PCs), notebook PCs, portable game terminals, portable/dongle-type mobile routers and digital cameras) or in-vehicle terminals (such as car navigation devices). The user equipments may also be implemented as terminals performing machine-to-machine (M2M) communication (also referred to as machine type communication (MTC) terminals). Furthermore, the user equipments may be wireless communication modules (such as integrated circuit modules comprising a single die) mounted on each of the above terminals. In some cases, the user equipments may communicate using a variety of wireless communication technologies. For example, the user equipments may be configured to communicate using two or more of GSM, UMTS, CDMA2000, WiMAX, LTE, LTE-A, WLAN, NR, Bluetooth, and the like. In some cases, the user equipments may also be configured to communicate using only one wireless communication technology.

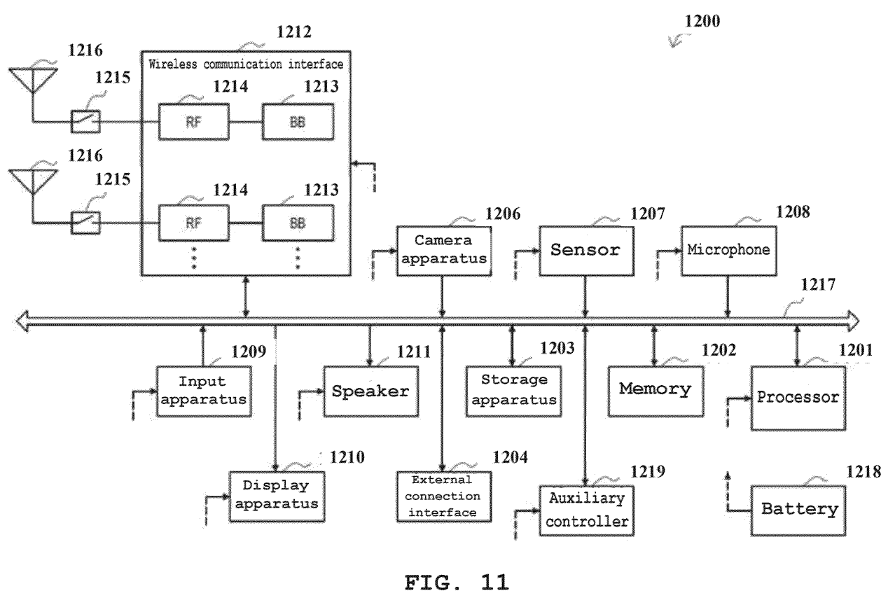

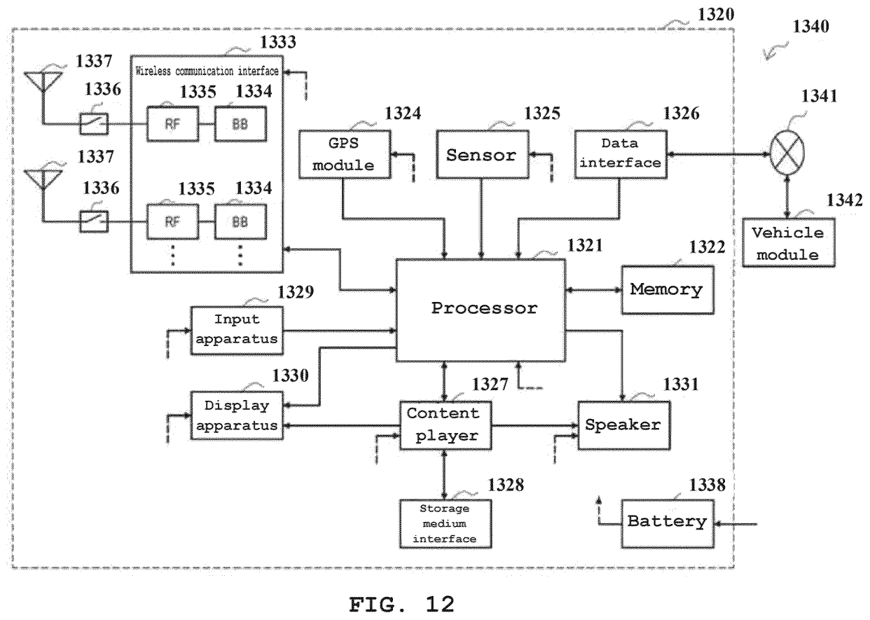

Examples according to the present disclosure will be described below with reference to FIGS. 11 to 12.

### Examples for User Equipments

### First Example

FIG. 11 is a block diagram showing an example of a schematic configuration of a smart phone 1200 to which the technology of the present disclosure may be applied. The smart phone 1200 includes a processor 1201, a memory 1202, a storage apparatus 1203, an external connection interface 1204, a camera apparatus 1206, a sensor 1207, a microphone 1208, an input apparatus 1209, a display apparatus 1210, a speaker 1211, a wireless communication interface 1212, one or more antenna switches 1215, one or more antennas 1216, a bus 1217, a battery 1218, and an auxiliary controller 1219. In one implementation, the smart phone 1200 (or the processor 1201) here may correspond to a first user equipment (or more specifically, the electronic device 200) or a second user equipment (or more specifically, the electronic device 300) in the above wireless communication system.

The processor 1201 may be, for example, a CPU or a system on a chip (SoC), and controls functions of the application layer and further layers of the smart phone 1200. The memory 1202 includes RAM and ROM, and stores data and programs executed by the processor 1201. The storage apparatus 1203 may include a storage medium such as a semiconductor memory and a hard disk. The external connection interface 1204 is an interface for connecting an external apparatus (such as a memory card and a Universal Serial Bus (USB) apparatus) to the smart phone 1200.

The camera apparatus 1206 includes an image sensor (such as a charge coupled device (CCD) and a complementary metal oxide semiconductor (CMOS)), and generates captured images. The sensor 1207 may include a set of sensors, such as measurement sensors, gyroscope sensors, geomagnetic sensors, and acceleration sensors. The microphone 1208 converts the sound input to the smart phone 1200 into an audio signal. The input apparatus 1209 includes, for example, a touch sensor configured to detect a touch on the screen of the display apparatus 1210, a keypad, a keyboard, a button, or a switch, and receives operations or information input from a user. The display apparatus 1210 includes a screen (such as a liquid crystal display (LCD) and an organic light emitting diode (OLED) display), and displays an output image of the smart phone 1200. The speaker 1211 converts an audio signal output from the smart phone 1200 into sound.

The wireless communication interface 1212 supports any cellular communication scheme (such as LTE and LTE-Advanced), and performs wireless communication. The wireless communication interface 1212 may generally include, for example, a BB processor 1213 and an RF circuit 1214. The BB processor 1213 may perform, for example, encoding/decoding, modulation/demodulation, and multiplexing/demultiplexing, and perform various types of signal processing for wireless communication. Meanwhile, the RF circuit 1214 may include, for example, a mixer, a filter, and an amplifier, and transmit and receive wireless signals via the antenna 1216. The wireless communication interface 1212 may be a chip module on which the BB processor 1213 and the RF circuit 1214 are integrated. As shown in FIG. 11, the wireless communication interface 1212 may include multiple BB processors 1213 and multiple RF circuits 1214. Although FIG. 11 illustrates an example in which the wireless communication interface 1212 includes multiple BB processors 1213 and multiple RF circuits 1214, the wireless communication interface 1212 may include a single BB processor 1213 or a single RF circuit 1214.

Furthermore, in addition to cellular communication schemes, the wireless communication interface 1212 may support additional types of wireless communication schemes, such as short-range wireless communication schemes, near field communication schemes, and wireless local area network (LAN) schemes. In this case, the wireless communication interface 1212 may include a BB processor 1213 and an RF circuit 1214 for each wireless communication scheme.

Each of the antenna switches 1215 switches the connection destination of the antenna 1216 among a plurality of circuits (e.g., circuits for different wireless communication schemes) included in the wireless communication interface 1212.

Each of the antennas 1216 includes a single or multiple antenna elements (such as multiple antenna elements included in a MIMO antenna), and is used for the wireless communication interface 1212 to transmit and receive wireless signals. As shown in FIG. 11, the smart phone 1200 may include multiple antennas 1216. Although FIG. 11 illustrates an example in which the smart phone 1200 includes multiple antennas 1216, the smart phone 1200 may also include a single antenna 1216.

Furthermore, the smart phone 1200 may include an antenna 1216 for each wireless communication scheme. In this case, the antenna switch 1215 may be omitted from the configuration of the smart phone 1200.

The bus 1217 connects the processor 1201, the memory 1202, the storage apparatus 1203, the external connection interface 1204, the camera apparatus 1206, the sensor 1207, the microphone 1208, the input apparatus 1209, the display apparatus 1210, the speaker 1211, the wireless communication interface 1212, and the auxiliary controller 1219 to each other. The battery 1218 provides power to the various blocks of the smart phone 1200 shown in FIG. 11 via feeders, which are partially shown in dashed lines in the figure. The auxiliary controller 1219 operates the minimum necessary functions of the smart phone 1200, e.g., in sleep mode.

### Second Example

FIG. 12 is a block diagram showing an example of a schematic configuration of a car navigation device 1320 to which the technology of the present disclosure may be applied. The car navigation device 1320 includes a processor 1321, a memory 1322, a global positioning system (GPS) module 1324, a sensor 1325, a data interface 1326, a content player 1327, a storage medium interface 1328, an input apparatus 1329, a display apparatus 1330, a speaker 1331, a wireless communication interface 1333, one or more antenna switches 1336, one or more antennas 1337, and a battery 1338. In one implementation, the car navigation device 1320 (or the processor 1321) here may correspond to a first user equipment (or more specifically, the electronic device 200) or a second user equipment (or more specifically, the electronic device 300) in the above wireless communication system.

The processor 1321 may be, for example, a CPU or a SoC, and controls the navigation function and other functions of the car navigation device 1320. The memory 1322 includes RAM and ROM, and stores data and programs executed by the processor 1321.

The GPS module 1324 uses GPS signals received from GPS satellites to measure the location (such as latitude, longitude, and altitude) of the car navigation device 1320. The sensor 1325 may include a set of f sensors such as a gyroscope sensor, a geomagnetic sensor, and an air pressure sensor. The data interface 1326 is connected to, for example, an in-vehicle network 1341 via a terminal not shown, and acquires data (such as vehicle speed data) generated by the vehicle.

The content player 1327 reproduces content stored in storage media (such as CDs and DVDs), which are inserted into the storage medium interface 1328. The input apparatus 1329 includes, for example, a touch sensor configured to detect a touch on the screen of the display apparatus 1330, a button, or a switch, and receives operations or information input from a user. The display apparatus 1330 includes a screen such as an LCD or OLED display, and displays images of a navigation function or reproduced content. The speaker 1331 outputs the sound of the navigation function or the reproduced content.

The wireless communication interface 1333 supports any cellular communication scheme (such as LTE and LTE-Advanced), and performs wireless communication. The wireless communication interface 1333 may generally include, for example, BB processor 1334 and RF circuit 1335. The BB processor 1334 may perform, for example, encoding/decoding, modulation/demodulation, and multiplexing/demultiplexing, and perform various types of signal processing for wireless communication. Meanwhile, the RF circuit 1335 may include, for example, a mixer, a filter, and an amplifier, and transmit and receive wireless signals via the antenna 1337. The wireless communication interface 1333 may also be a chip module on which the BB processor 1334 and the RF circuit 1335 are integrated. As shown in FIG. 12, the wireless communication interface 1333 may include multiple BB processors 1334 and multiple RF circuits 1335. Although FIG. 12 illustrates an example in which the wireless communication interface 1333 includes multiple BB processors 1334 and multiple RF circuits 1335, the wireless communication interface 1333 may also include a single BB processor 1334 or a single RF circuit 1335.

Furthermore, in addition to the cellular communication scheme, the wireless communication interface 1333 may support another type of wireless communication scheme, such as a short-range wireless communication scheme, a near field communication scheme, and a wireless LAN scheme. In this case, the wireless communication interface 1333 may include the BB processor 1334 and the RF circuit 1335 for each wireless communication scheme.

Each of the antenna switches 1336 switches the connection destination of the antenna 1337 among a plurality of circuits (such as circuits for different wireless communication schemes) included in the wireless communication interface 1333.

Each of the antennas 1337 includes a single or multiple antenna elements (such as multiple antenna elements included in a MIMO antenna), and is used for the wireless communication interface 1333 to transmit and receive wireless signals. As shown in FIG. 12, the car navigation device 1320 may include multiple antennas 1337. Although FIG. 12 illustrates an example in which the car navigation device 1320 includes multiple antennas 1337, the car navigation device 1320 may also include a single antenna 1337.

Furthermore, the car navigation device 1320 may include an antenna 1337 for each wireless communication scheme. In this case, the antenna switch 1336 may be omitted from the configuration of the car navigation device 1320.

The battery 1338 provides power to various blocks of the car navigation device 1320 shown in FIG. 12 via feeders, which are partially shown in dashed lines in the figure. The battery 1338 accumulates power supplied from the vehicle.

The techniques of this disclosure may also be implemented as an in-vehicle system (or vehicle) 1340 including one or more blocks of the car navigation device 1320, the in-vehicle network 1341, and the vehicle module 1342. The vehicle module 1342 generates vehicle data (such as vehicle speed, engine speed, and fault information), and outputs the generated data to the in-vehicle network 1341.

The exemplary embodiments of the present disclosure have been described above with reference to the drawings, but the present disclosure is not of course limited to the above examples. Those skilled in the art may find various changes and modifications within the scope of the appended claims, and it should be understood that these changes and modifications will naturally fall within the technical scope of the present disclosure.

For example, a plurality of functions included in one unit in the above embodiments may be implemented by separate apparatus. Alternatively, the plurality of functions implemented by multiple units in the above embodiments may be implemented by separate apparatus, respectively. Additionally, one of the above functions may be implemented by multiple units. Needless to say, such a configuration is included in the technical scope of the present disclosure.

In this specification, the steps described in the flowchart include not only processes performed in time sequence in the stated order, but also processes performed in parallel or individually rather than necessarily in time sequence. Furthermore, even in the steps processed in time sequence, needless to say, the order may be appropriately changed.

Although the present disclosure and its advantages have been described in detail, it should be understood that various changes, substitutions and alterations may be made herein without departing from the spirit and scope of the disclosure as defined by the appended claims. Furthermore, the terms “comprise”, “include” or any other variation thereof in embodiments of the present disclosure are intended to encompass a non-exclusive inclusion, such that a process, method, article or device comprising a series of elements includes not only those elements, but also include other elements not expressly listed, or include elements inherent to such process, method, article or device. Without further limitation, an element defined by the phrase “comprising one . . . ” does not preclude the presence of additional identical elements in a process, method, article or device that includes the element.

1. An electronic device for a first user equipment in a wireless communication system, the electronic device comprising a processing circuit configured to cause the first user equipment to perform:
receiving, through a first antenna panel installed on the first user equipment, a reference signal transmitted by a third antenna panel of a second user equipment installed thereon, wherein a time resource and/or frequency resource occupied by the reference signal are associated with a position of the third antenna panel on the second user equipment; and
determining, based on an association relationship between the position of the third antenna panel on the second user equipment and one or more time resources and/or frequency resources and the time resource and/or frequency resource occupied by the reference signal, the position of the third antenna panel on the second user equipment.

2. The electronic device according to claim 1, wherein:
the second user equipment further comprises a fourth antenna panel installed thereon, a time resource and/or frequency resource occupied by a reference signal transmitted by the fourth antenna panel being associated with a position of the fourth antenna panel on the second user equipment; and
the association relationship between the position of the third antenna panel on the second user equipment and one or more time resources and/or frequency resources and the association relationship between the position of the fourth antenna panel on the second user equipment and one or more time resources and/or frequency resources are determined by default, or are notified in advance to the first user equipment by the second user equipment, wherein the one or more time resources and/or frequency resources associated with the third antenna panel and the one or more time resources and/or frequency resources associated with the fourth antenna panel are independent of each other.

3. The electronic device according to claim 1, wherein the reference signal comprises a positioning reference signal or a synchronization reference signal.

4. The electronic device according to claim 2, wherein:
the third antenna panel is located at the front of the second user equipment, and the fourth antenna panel is located at the rear of the second user equipment.

5. The electronic device according to claim 4, the processing circuit is further configured to cause the first user equipment to perform:
determining a relative position of the first user equipment and the second user equipment.

6. The electronic device according to claim 5, wherein determining the relative position of the first user equipment and the second user equipment comprises:
receiving, through the first antenna panel, a first reference signal transmitted by the third antenna panel of the second user equipment;
receiving, through the first antenna panel, a second reference signal transmitted by the fourth antenna panel of the second user equipment; and
in response to the strength of the first reference signal being greater than the strength of the second reference signal, determining that the first user equipment is located in front of the second user equipment; or in response to the strength of the first reference signal being less than the strength of the second reference signal, determining that the first user equipment is located behind the second user equipment.

7. The electronic device according to claim 5, the processing circuit is further configured to cause the first user equipment to perform:
based on the relative position of the first user equipment and the second user equipment, receiving, through the first antenna panel, a reference signal transmitted by one of the third antenna panel or the fourth antenna panel, for measuring the distance between the first user equipment and the second user equipment.

8. The electronic device according to claim 5, the processing circuit is further configured to, in response to the first user equipment and the second user equipment moving in the same straight line:
based on the relative position of the first user equipment and the second user equipment, and based on a measured first distance from the third antenna panel of the second user equipment and a measured second distance from the fourth antenna panel of the second user equipment by the first antenna panel, determine whether there is an abnormality in the movement between the first user equipment and the second user equipment.

9. The electronic device according to claim 8, wherein determining whether there is an abnormality in the movement between the first user equipment and the second user equipment comprises:
in response to the first user equipment being located in front of the second user equipment, based on the first distance being greater than the second distance, determining that there is an abnormality in the movement between the first user equipment and the second user equipment; or
in response to the first user equipment being located behind the second user equipment, based on the first distance being less than the second distance, determining that there is an abnormality in the movement between the first user equipment and the second user equipment.

10. The electronic device according to claim 4, wherein:
the first user equipment further comprises a second antenna panel installed thereon, and
the first antenna panel is located at the front of the first user equipment, and the second antenna panel is located at the rear of the first user equipment.

11. The electronic device according to claim 10, the processing circuit is further configured to cause the first user equipment to perform:
determining a relative position of the first user equipment and the second user equipment.

12. The electronic device according to claim 11, wherein determining the relative position of the first user equipment and the second user equipment comprises:
receiving, through the first antenna panel, a first reference signal transmitted by one of the third antenna panel or the fourth antenna panel of the second user equipment;
receiving, through the second antenna panel, a second reference signal transmitted by the one of the third antenna panel or the fourth antenna panel of the second user equipment; and
in response to the strength of the first reference signal being greater than the strength of the second reference signal, determining that the first user equipment is located behind the second user equipment; or in response to the strength of the first reference signal being less than the strength of the second reference signal, determining that the first user equipment is located in front of the second user equipment.

13. The electronic device according to claim 11, the processing circuit is further configured to cause the first user equipment to perform:
based on the relative position of the first user equipment and the second user equipment, receiving, through one of the first antenna panel or the second antenna panel, a reference signal transmitted by one of the third antenna panel or the fourth antenna panel, for measuring the distance between the first user equipment and the second user equipment.

14. The electronic device according to claim 13, wherein:
in response to the first user equipment being located in front of the second user equipment, receiving, through the second antenna panel, a reference signal transmitted by the third antenna panel, for measuring the distance between the first user equipment and the second user equipment; or
in response to the first user equipment being located behind the second user equipment, receiving, through the first antenna panel, a reference signal transmitted by the fourth antenna panel, for measuring the distance between the first user equipment and the second user equipment.

15. The electronic device according to claim 1, wherein the first user equipment is a vehicle and the second user equipment is a vehicle.

16. An electronic device for a second user equipment in a wireless communication system, the electronic device comprising a processing circuit configured to cause the second user equipment to perform:
transmitting a reference signal to a first user equipment using a third antenna panel installed on the second user equipment, a time resource and/or frequency resource occupied by the reference signal being associated with a position of the third antenna panel on the second user equipment, so that the first user equipment determines the position of the third antenna panel on the second user equipment based on an association relationship between the position of the third antenna panel on the second user equipment and one or more time resources and/or frequency resources and the time resource and/or frequency resource occupied by the reference signal.

17. The electronic device according to claim 16, wherein:
the second user equipment further comprises a fourth antenna panel installed thereon, a time resource and/or frequency resource occupied by the reference signal transmitted by the fourth antenna panel being associated with the position of the fourth antenna panel on the second user equipment; and
the association relationship between the position of the third antenna panel on the second user equipment and one or more time resources and/or frequency resources, and the association relationship between the position of the fourth antenna panel on the second user equipment and one or more time resources and/or frequency resources are determined by default, or are notified in advance to the first user equipment by the second user equipment, wherein the one or more time resources and/or frequency resources associated with the third antenna panel and the one or more time resources and/or frequency resources associated with the fourth antenna panel are independent of each other.

18. A method for a first user equipment in a wireless communication system, the method comprising:
receiving, through a first antenna panel installed on the first user equipment, a reference signal transmitted by a third antenna panel of a second user equipment installed thereon, wherein a time resource and/or frequency resource occupied by the reference signal being associated with a position of the third antenna panel on the second user equipment; and
determining, based on an association relationship between the position of the third antenna panel on the second user equipment and one or more time resources and/or frequency resources and the time resource and/or frequency resource occupied by the reference signal, the position of the third antenna panel on the second user equipment.

19. A method for a second user equipment in a wireless communication system, the method comprising:
transmitting a reference signal to a first user equipment using a third antenna panel installed on the second user equipment, a time resource and/or frequency resource occupied by the reference signal being associated with a position of the third antenna panel on the second user equipment, so that the first user equipment determines the position of the third antenna panel on the second user equipment based on an association relationship between the position of the third antenna panel on the second user equipment and one or more time resources and/or frequency resources and the time resource and/or frequency resource occupied by the reference signal.

20. A computer-readable storage medium having one or more executable instructions stored thereon, which, when executed by one or more processors of an electronic device, cause the electronic device to perform the method according to claim 18.

21. (canceled)
